(19) United States
(12) Patent Application Publication
(10) Pub. No.: US 2011/0183206 A1
(43) Pub. Date: Jul. 28, 2011

(54) APPARATUS, SYSTEM, AND METHOD FOR CARBON NANOTUBE TEMPLATED BATTERY ELECTRODES

(75) Inventors: Robert C. Davis, Provo, UT (US); Richard R. Vanfleet, Provo, UT (US); John Harb, Woodland Hills, UT (US); Jun Song, Provo, UT (US)

(73) Assignee: Brigham Young University, Provo, UT (US)

(21) Appl. No.: 12/959,227

(22) Filed: Dec. 2, 2010

Related U.S. Application Data
(60) Provisional application No. 61/283,280, filed on Dec. 2, 2009.

(51) Int. Cl. H01M 4/58; H01M 4/66; H01M 4/26; F27D 19/00; B05D 5/12; B05D 3/02; B82Y 99/00; B82Y 40/00

(52) U.S. Cl. 429/218.1; 429/245; 29/623.5; 431/18; 427/113; 977/948; 977/842; 977/891

(57) ABSTRACT

An apparatus, system, and method are disclosed for a carbon nanotube templated battery electrode. The apparatus includes a substrate, and a plurality of catalyst areas extending upward from the substrate, the plurality of catalyst areas forming a patterned frame. The apparatus also includes a carbon nanotube forest grown on each of the plurality of catalyst areas and extending upward therefrom such that a shape of the patterned frame is maintained, and a coating attached to each carbon nanotube in the carbon nanotube forest, the coating formed of an electrochemically active material. The system includes the apparatus, and a particulate cathode material distributed evenly across the apparatus such that the particulate cathode material fills the passages, a current collector film formed on top of the particulate cathode material, and a porous spacer disposed between the apparatus and the cathode.

### CROSS-REFERENCES TO RELATED APPLICATIONS

This application claims priority to U.S. Provisional Patent Application No. 61/283,280 entitled HIGH CAPACITY AND HIGH ASPECT RATIO ELECTROCHEMICAL MATERIALS and filed on Dec. 2, 2009 for Robert Davis et al. which is incorporated herein by reference.

### TECHNICAL FIELD

This disclosure relates to electrodes and more particularly relates to carbon nanotube templated battery electrodes.

### BACKGROUND

### Description of the Related Art

Lithium ion based batteries are popular because of their energy to weight ratios, lack of a memory effect, and a slow loss of charge when not in use. Traditionally, lithium ion batteries use lithium cobalt oxide as a cathode and carbon or graphite as the anode. Research efforts have focused on metals or alloys that will form alloys with lithium because such materials will store much more energy than a carbon or graphite anode. For example, silicon has a theoretical energy capacity of about 4000 mAh/g.

However, the use of lithium alloys has been limited due to the expansion and contraction of the lithium alloy material during a charging/discharging cycle. For instance, silicon expands approximately 300% when fully charged. The problem with the expansion and contraction during the charge/discharge cycle is cracking or fragmenting of silicon. When the silicon anode undergoes such volume changes, the anode often loses electrical contact with a current collector and the battery is no longer useful.

### SUMMARY

The present disclosure has been developed in response to the present state of the art, and in particular, in response to the problems and needs in the art that have not yet been fully solved by currently available electrodes. Accordingly, the present disclosure has been developed to provide an apparatus, system, and method for carbon nanotube templated battery electrodes that overcome many or all of the above-discussed shortcomings in the art.

The apparatus includes a substrate, and a plurality of catalyst areas extending upward from the substrate, the plurality of catalyst areas forming a patterned frame. In a further embodiment, the apparatus also includes a carbon nanotube forest grown on each of the plurality of catalyst areas and extending upward therefrom such that a shape of the patterned frame is maintained, and a coating attached to each carbon nanotube in the carbon nanotube forest, the coating formed of an electrochemically active material.

In one embodiment, the catalyst areas comprise lithographically attached catalyst areas, and a pitch of the patterned frame is in the range of between about 1 and 100 μm. Furthermore, the height of the carbon nanotube forest is in the range of between about 1 and 100 μm. The catalyst areas may be formed of a sheet of conductive material and coated on both sides with a layer of Al₂O₃, and the conductive material is stainless steel. In a further embodiment, the electrochemically active material comprises vapor-deposited silicon, having a thickness in the range of between about 1 and 100 nm.

A system of the present disclosure is also presented. The system, in one embodiment, includes an anode comprising the above described apparatus, and a cathode comprising a particulate cathode material distributed evenly across the anode such that the particulate cathode material fills the passages, a current collector film formed on top of the particulate cathode material. The system also includes a porous spacer disposed between the anode and the cathode.

In one example, the plurality of catalyst areas is formed of a sheet of conductive material. The porous spacer material is a sputtered electrically insulating material. Additionally, the electrochemically active material comprises vapor-deposited silicon having a thickness in the range of between about 1 and 100 nm.

A method of the present disclosure is also presented for providing a carbon nanotube templated electrode. In one embodiment, the method includes providing a substrate, and lithographically depositing a plurality of catalyst areas extending upward from the substrate, the plurality of catalyst areas forming a patterned frame. The method also includes growing a carbon nanotube forest on each of the plurality of catalyst areas and extending upward therefrom such that a shape of the patterned frame is maintained and chemical vapor depositing a coating attached to each carbon nanotube in the carbon nanotube forest, the coating formed of an electrochemically active material.

In a further embodiment, growing a carbon nanotube forest comprises growing vertically aligned carbon nanotubes to a height of between about 1 and 100 μm, and depositing the electrochemically active material at a temperature of between about 100 and 800° C. The method also includes annealing the electrochemically active material at a temperature in the range of between about 500 and 900° C. for a time of between about 4 and 16 hours.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a side view diagram illustrating a cross-sectional view of one embodiment of a carbon nanotube templated battery;

FIG. 2 is a perspective view diagram illustrating one embodiment of carbon nanotube forests grown from patterned catalyst material;

FIG. 3a is scanning electron microscope (SEM) image illustrating a carbon nanotubes forest;

FIG. 3b is a SEM image illustrating one embodiment of a silicon coated carbon nanotube;

FIG. 3c is a SEM image illustrating another embodiment of a silicon coated carbon nanotube;

FIG. 3d is a cross sectional image illustrating silicon coated carbon nanotubes;

FIG. 4 is a side view diagram illustrating one embodiment of a single, coated carbon nanotube; and

FIG. 5 is a schematic diagram illustrating one embodiment of patterned or templated carbon nanotube growth.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided to give a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

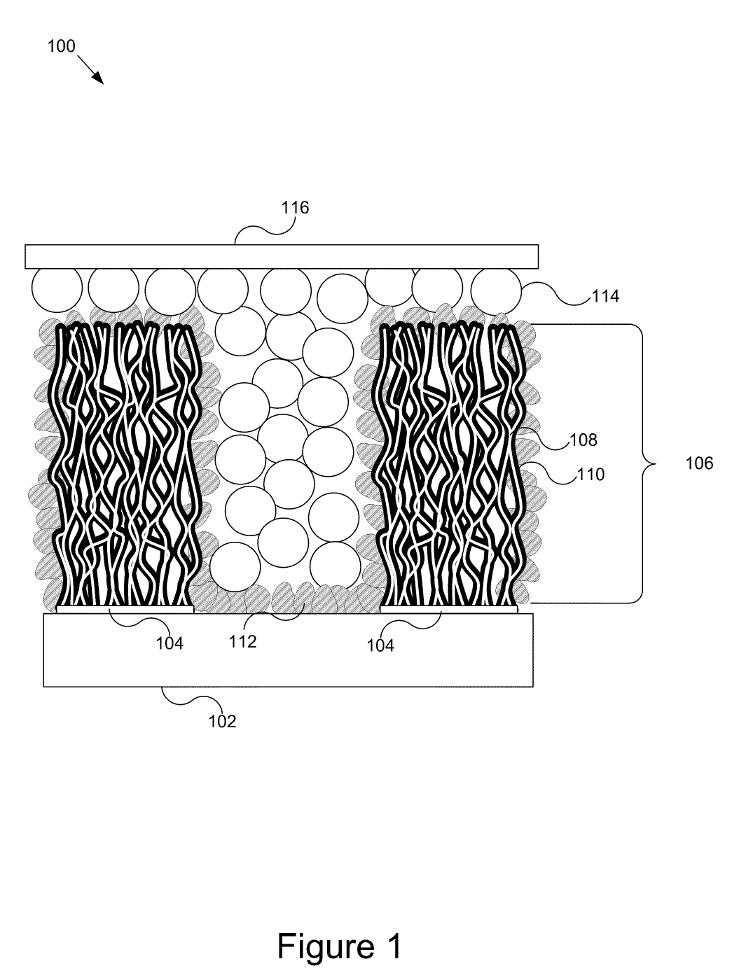

FIG. 1 is a side view diagram illustrating a cross-sectional view of one embodiment of a carbon nanotube templated battery 100. In one embodiment, the battery 100 includes a substrate 102, a patterned catalyst 104 formed on the substrate 102, and a vertically aligned carbon nanotube forest 106 grown on each patterned catalyst 104. The carbon nanotube forest 106 comprises a plurality of vertically aligned carbon nanotubes 108 coated with an electrochemically active material 110.

The battery 100, as illustrated, may also include a porous spacer 112 disposed between the carbon nanotube forest 106 and a particulate cathode material 114. The particulate cathode material 114 is capable of filling in the openings, or passages, between adjacent carbon nanotube forests 106, and thereby forming an interdigitated cathode. In other words, the cathode material 114 extends into the passages formed by the carbon nanotube forests. A current collecting film 116 may be deposited on top of the cathode material 114. Examples of a current collecting film suitable for use in the present disclosure include, but are not limited to, copper, and nickel.

As will be discussed in greater detail below, the carbon nanotube forests 106 are grown vertically from the substrate or catalyst. The term “vertically grown” is used to describe nanotubes that are grown upward from a substrate or catalyst material. While such nanotubes exhibit a generally vertical attitude, it is to be understood that such tubes are not necessarily perfectly straight or perfectly upright, but will tend to grow, twist, or otherwise meander laterally to some degree, as illustrated in FIG. 1. Likewise, the term “vertically aligned” refers to the generally linear nature in which the carbon nanotubes extend upward from the patterned catalyst material 104. It is to be understood that while the carbon nanotubes meander, the carbon nanotubes generally extend lengthwise from the substrate.

Furthermore, as used herein, relative terms such as “upper,” “lower,” “downwardly,” “vertically,” etc., are used to refer to various components, and orientations of components and related structures. It is to be understood that such terms are not intended to limit the disclosure; rather, they are intended to aid in describing the structures generally.

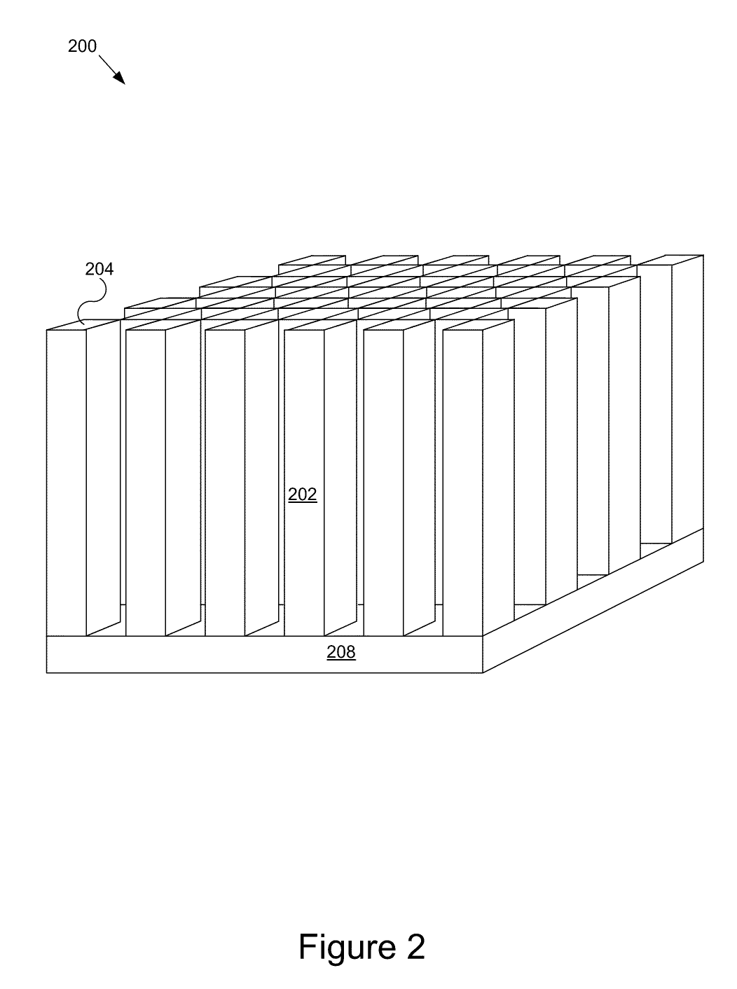

FIG. 2 is a perspective view diagram illustrating one embodiment of carbon nanotube forests grown from patterned catalyst material. As used herein, the term “carbon nanotube forest” refers to the grouping of carbon nanotubes grown from a single catalyst site. In the depicted embodiment, the multiple carbon nanotube forests 202 are arranged in a patterned frame 200. In one embodiment, the patterned frame 200 resembles a framework or grate, where a carbon nanotube forest 202 may support up to four surrounding carbon nanotube forests 202. Beneficially, this increases the strength of the patterned frame 200.

In the depicted embodiment, the carbon nanotube forests 202 are formed in generally square or rectangular pillars. The arrangement of the pillars forms passages 204, or openings in the patterned frame 200. These passages, in one embodiment, extend from an upper planar surface formed by the tops 206 of the carbon nanotube forests to the substrate 208. In the example shown, the passages 204 also are formed in a generally square or rectangular shape. However, the patterned frame 200 may be formed having a variety of shapes including, but not limited to, diamond, oval, circular, and trapezoidal shapes.

The walls of the carbon nanotube forests 202 can extend in divergent directions, forming right angles relative to one another, or a variety of other angles depending upon the desired pattern of the patterned frame 200. The pattern, shape, and geometry of the patterned frame 200 can be manipulated during the carbon nanotube growth process, thereby providing a great deal of flexibility in designing the battery.

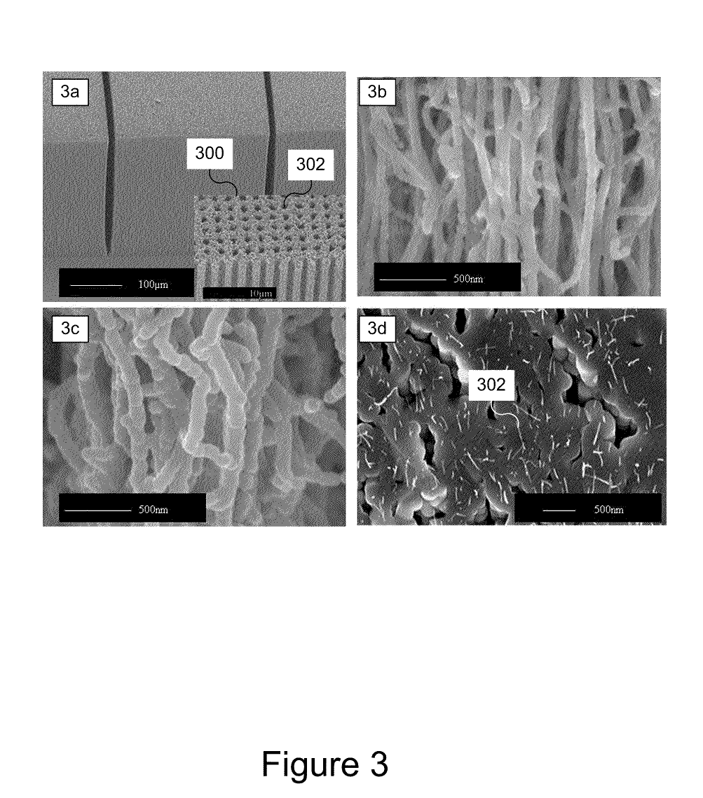

FIGS. 3a-d are scanning electron microscope (SEM) images illustrating carbon nanotubes coated with an electrochemically active material. The carbon nanotubes, in one embodiment, are coated with the electrochemically active material using chemical vapor infiltration. Beneficially, the carbon nanotubes provide a highly porous template for the electrochemically active material, and provide an electrical connection to a current collector.

Another benefit of the nanostructure, or patterned frame, is the ability to control the relative influence of the solid phase transport of electrons and the transport of ions in the electrode, and therefore the performance of the electrode by varying the dimensions of the nanostructure. Examples of dimensions that influence the performance of the electrode include the aspect ratio of a carbon nanotube forest (height vs. cross-sectional area), and the pitch of the patterned frame (where pitch refers to the distance between two similar points on the patterned frame, for example, the distance between the center of one carbon nanotube forest to the center of an adjacent carbon nanotube forest). This dimensional control also allows control over the surface to volume ratio of the electrochemically active material. An additional benefit of dimensional control, and the patterned frame, is the ability to reduce the transport resistance between an anode and cathode by filling the passages (see FIG. 2) with a cathode material (see FIG. 1), which reduces the distance lithium ions have to travel. In one example, the components of the battery 100 (see FIG. 1) which form the anode include the substrate 102, the catalyst area 104 (which may function as a current collector), and the carbon nanotube forest 106. The components of FIG. 1 which form the cathode, in one example, include the cathode material 114 and the current collector 116.

One example of a suitable electrochemically active material for coating the carbon nanotubes is silicon. Alternatively, any electrode material capable of coating a carbon nanotube via chemical vapor infiltration may be used. The silicon coating may be crystalline silicon, amorphous silicon, or silicon compounds. The carbon nanotubes provide a high surface area support structure for the silicon that electrically connects the silicon to a current collector and maintains that electrical connection during the expansion or contraction of the silicon during a discharging or charging cycle, respectively. Volume expansion can be accommodated by controlling the volume fraction of silicon on the carbon nanotubes.

Volume expansion and contraction of the silicon occurs because of the lithiation process. Lithiation is the process of electrons being released from a lithium electrode and moving through an external circuit to the silicon. Lithium ions have a lower potential than that of electrochemically active materials, such as silicon, and therefore, lithium ions diffuse to and intercalate into the silicon during a battery discharging event. During a charging event, the reverse occurs. This intercalation of lithium causes volume contraction of up to 4× the original volume of the silicon, which causes changes in the structure, capacity, and rate capability of the silicon.

FIG. 3a is a perspective view image illustrating one embodiment of the patterned frame 300. The patterned frame 300 is similar to that described above with reference to FIG. 2. The silicon coated carbon nanotubes may be grown, in one example, to a height of about 300 μm. The insert of FIG. 3a illustrates, in greater detail, the patterned frame 300. Specifically, the insert illustrates multiple individual carbon nanotube forests joining to form a patterned grid 300. Passages 302 are formed as a result.

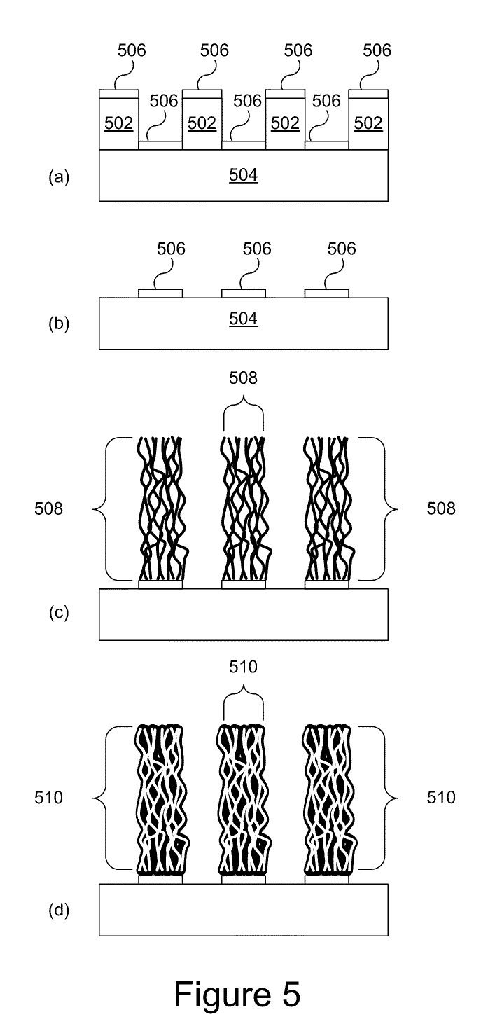

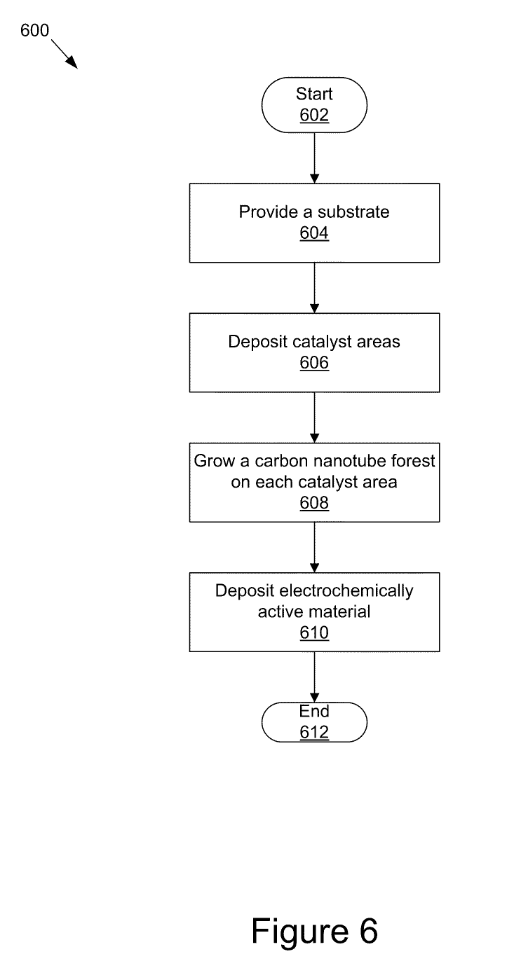

FIG. 3b is a scanning electron microscope image of silicon coated carbon nanotubes. The process by which silicon coats the carbon nanotubes will be described in greater detail below with reference to FIG. 5. However, FIGS. 3b and 3c illustrate the effect temperature can have during chemical vapor deposition. Both FIGS. 3b and 3c illustrate silicon carbon nanotubes synthesized with silane. FIG. 3b was synthesized at 530° C., while FIG. 3c illustrates a silicon carbon nanotube synthesized at 560° C.

FIG. 3d is a cross sectional image illustrating silicon carbon nanotubes. In the image, silicon 304 is illustrated as the darker material, with the carbon nanotubes 306 the lighter “streaks” extending from the silicon 302. At low deposition temperatures, and for carbon nanotube forests with a height less than 30 μm, it is possible to nearly fill the carbon nanotube forest with silicon so that the volume fraction of silicon is greater than 90%.

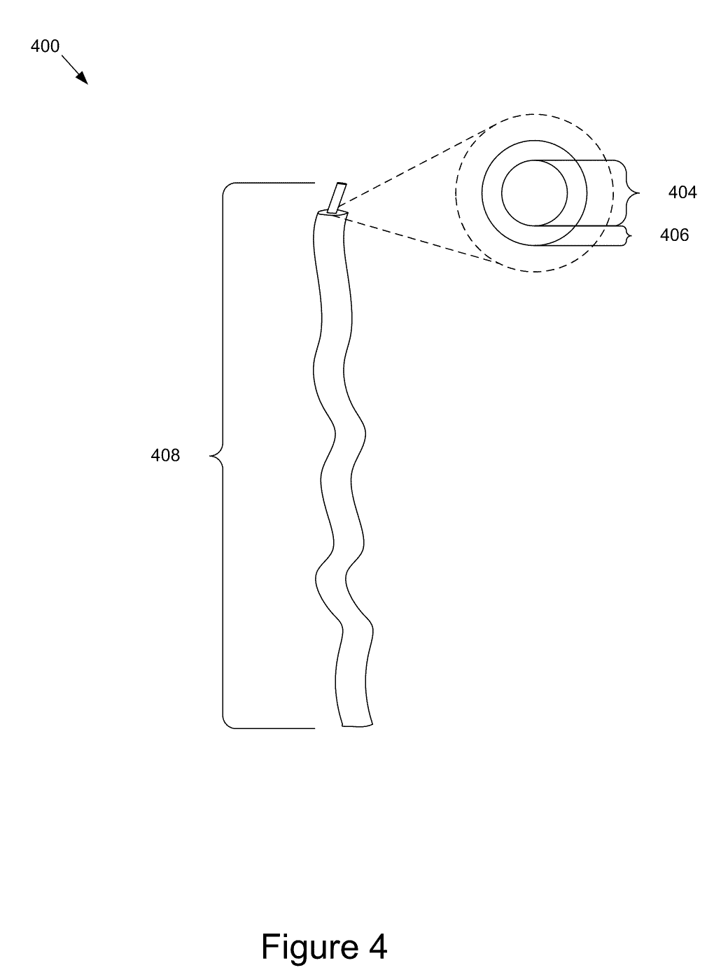

FIG. 4 is a side view diagram illustrating one embodiment of a single, coated carbon nanotube 400. As described above, the carbon nanotube 402 grows in a generally upward direction. Although the carbon nanotube may meander during growth, the result is a high aspect ratio nanostructure. One benefit of the meandering nature of the carbon nanotube 402, is that although the carbon nanotube 402 is vertically aligned with adjacent carbon nanotubes in the forest, the carbon nanotubes contact each other at various points, creating redundant electrical paths to the current collector.

In one embodiment, the diameter 404 of the carbon nanotube 402 is in the range of between about 3 and 90 nm. The thickness 406 of the silicon coating is in the range of between about 1 and 50 nm. The thickness of the silicon is selected according to a desired energy capacity or energy density of a battery. The height 408 of a silicon coated carbon nanotube is in the range of between about 1 and 200 μm. The above ranges of dimensions are controlled by varying the run time for the carbon nanotube growth and the run time and temperature of silicon deposition, as will be discussed in greater detail below with reference to FIG. 5.

FIG. 5 is a schematic diagram illustrating one embodiment of patterned or templated carbon nanotube growth. One example of the processing steps involved in fabricating templated carbon nanotube battery electrodes include: (a) depositing a lithographically patterned photoresist 502 on a substrate 504, and depositing a catalyst; (b) removing the photoresist; (c) growing carbon nanotube forests 508 on the patterned catalysts; and (d) depositing an electrochemically active coating on the carbon nanotube.

Referring first to steps (a) and (b), the substrate 504, in one embodiment is a silicon wafer, having a catalyst stack 506 formed of 30 nm of Al₂O₃ and 3 nm of Fe. Alternatively, the catalyst may be formed of a stainless steel foil coated with a thin layer of Al₂O₃. Beneficially, the stainless steel foil also functions as a current collector. The substrate is patterned by photo lithography and after lift-off, a pattern of catalyst areas remains. The catalyst areas 506 form the patterned frame of FIG. 2. In one example, each catalyst area 506 is formed having a generally square shape where the length of one leg of the square is in the range of between about 1 and 100 μm. Correspondingly, the area of a catalyst (which defines the patterned frame) is in the range of between about 1 and 10,000 μm². The pitch of the patterned frame is also in the range of between about 1 and 100 μm. The exact dimension is selected based on a number of factors, including, but not limited to, desired energy density, etc.

Following the removal of the photoresist, carbon nanotubes (c) are then grown. In one embodiment, the resulting substrate can be placed on a quartz “boat” in a one inch quartz tube furnace and heated from room temperature to about 750° C. while flowing 500 sccm of H₂. When the furnace reaches 750° C. (after about 8 minutes), a C₂H₄ flow can be initiated at 700 sccm (if slower growth is desired, the gases may be diluted with argon). After a desired carbon nanotube length (or height) is obtained, the H₂ and C₂H₄ gases can be removed, and Ar can be initiated at 350 sccm while cooling the furnace to about 200° C. in about 5 minutes. The height of the carbon nanotubes is controlled by varying the run time. In one example, a run time of 2 minutes resulted in 100 μm tall carbon nanotubes.

The above example generated multi-walled carbon nanotubes with an average diameter of about 8.5 nm and a density of about 9.0 kg/m. The above environment variables will also result in a carbon nanotube forest of high density, having interlocked or intertwined carbon nanotubes that can be grown very tall while maintaining very narrow features in the patterned frame.

The intertwining of the carbon nanotubes during growth is advantageous in that the carbon nanotubes maintain a lateral pattern (generally defined by a catalyst from which the carbon nanotubes are grown) while growing vertically upward, as the carbon nanotubes maintain an attraction to one another during growth. Thus, rather than achieving random growth in myriad directions, the carbon nanotubes collectively maintain a common, generally vertical attitude while growing.

An electrochemically active material is then deposited (d) by, in one embodiment, low pressure chemical vapor deposition. The carbon nanotubes, while illustrated as black lines in step (c), for clarity here are shown as white lines and the deposited electrochemically active material is illustrated as a black line. In one exemplary embodiment, at 530° C., thin amorphous silicon films were deposited onto the nanotubes by low pressure chemical vapor deposition where silane (20 sccm) was reacted with the specimen at elevated temperature and low pressure (150 mtorr). Crystalline silicon can be deposited at higher temperatures. In one embodiment, a uniform coating of crystalline silicon is achieved at a temperature of about 560° C. and then thermally annealed at 700° C. overnight.

At low deposition temperatures, the silicon deposition rate is predominantly limited by surface reaction kinetics and the coating is quite uniform throughout the thickness of the electrode. The passages formed in the patterned frame allow for silane vapor access deep into the carbon nanotube forest structure, thereby beneficially allowing areas of the carbon nanotube forests that would not normally be coated during chemical vapor deposition, to be coated. Additionally, the passages provide straight paths for ion diffusion into the anode.

The schematic flow chart diagram included herein is generally set forth as logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 6 is a schematic flow chart diagram illustrating a method 600 of forming a carbon nanotube templated electrode. The method 600 begins 602 and a substrate is provided 604. In one embodiment, the substrate is similar to the substrates described above with reference to FIGS. 1-3, and 5. The substrate in one embodiment is a silicon wafer. Photoresist may then be deposited on the substrate and patterned lithographically as described above with reference to FIG. 5. The method continues and a catalyst stack is deposited 606. The catalyst stack, in one embodiment, comprises a stainless steel foil coated on both sides with a thin layer of alumina. Alternatively, the catalyst stack is formed of alumina and iron.

Photoresist is removed, and carbon nanotubes are grown 608 on the remaining catalyst areas as described above in step (c) of FIG. 5. The carbon nanotubes maintain the patterned frame defined by the catalyst areas, and essentially turn the 2D patterned frame of catalyst areas into a 3D patterned frame of carbon nanotube forests. The method continues and an electrochemically active material is deposited 610 over the carbon nanotubes.

In one embodiment, depositing the electrochemically active material comprises a chemical vapor deposition or infiltration of silicon. The silicon may be crystalline, amorphous, or a silicon alloy. The conditions of the deposition are similar to those described above with reference to FIG. 5. The deposition continues until a desired silicon thickness is achieved, at which point the silicon may be annealed overnight at an elevated temperature. The method 600 then ends 612.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus for a templated battery electrode, the apparatus comprising:
a substrate;
a plurality of catalyst areas extending upward from the substrate, the plurality of catalyst areas forming a patterned frame;
a carbon nanotube forest grown on each of the plurality of catalyst areas and extending upward therefrom such that a shape of the patterned frame is maintained; and
a coating attached to each carbon nanotube in the carbon nanotube forest, the coating formed of an electrochemically active material.

2. The apparatus of claim 1, wherein the catalyst areas comprise lithographically attached catalyst areas.

3. The apparatus of claim 1, wherein a pitch of the patterned frame is in the range of between about 1 and 100 μm.

4. The apparatus of claim 1, wherein the height of the carbon nanotube forest is in the range of between about 1 and 100 μm.

5. The apparatus of claim 1, wherein each of the plurality of catalyst areas is formed of a sheet of conductive material and coated on both sides with a layer of Al₂O₃.

6. The apparatus of claim 5, wherein the conductive material is stainless steel.

7. The apparatus of claim 1, wherein the electrochemically active material comprises vapor-deposited silicon.

8. The apparatus of claim 7, wherein the vapor-deposited silicon has a thickness in the range of between about 1 and 100 nm.

9. A system for a carbon nanotube templated battery, the system comprising:
an anode comprising:
a substrate;
a plurality of catalyst areas extending upward from the substrate, the plurality of catalyst areas forming a patterned frame;
a carbon nanotube forest grown on each of the plurality of catalyst areas and extending upward therefrom such that a shape of the patterned frame is maintained, wherein the carbon nanotube forests of each of the plurality of catalyst areas defines a plurality of passages between adjacent carbon nanotube forests;
a coating attached to each carbon nanotube in the carbon nanotube forest, the coating formed of an electrochemically active material; and
a cathode comprising:
a particulate cathode material distributed evenly across the anode such that the particulate cathode material fills the passages;
a current collector film formed on top of the particulate cathode material; and
a porous spacer disposed between the anode and the cathode.

10. The system of claim 9, wherein each of the plurality of catalyst areas is formed of a sheet of conductive material.

11. The system of claim 9, wherein the porous spacer material comprises a sputtered electrically insulating material.

12. The system of claim 9, wherein the pitch of the patterned frame is in the range of between about 1 and 100 μm.

13. The system of claim 9, wherein the electrochemically active material comprises vapor-deposited silicon having a thickness in the range of between about 1 and 100 nm.

14. A method of forming a carbon nanotube templated electrode, the method comprising:
providing a substrate;
depositing a plurality of catalyst areas extending upward from the substrate, the plurality of catalyst areas forming a patterned frame;
growing a carbon nanotube forest on each of the plurality of catalyst areas and extending upward therefrom such that a shape of the patterned frame is maintained; and
chemical vapor depositing a coating attached to each carbon nanotube in the carbon nanotube forest, the coating formed of an electrochemically active material.

15. The method of claim 14, wherein the patterned frame has a pitch in the range of between about 1 and 100 μm.

16. The method of claim 14, wherein growing a carbon nanotube forest comprises growing vertically aligned carbon nanotubes to a height of between about 1 and 100 μm.

17. The method of claim 14, wherein the electrochemically active material is deposited at a temperature of between about 100 and 800° C.

18. The method of claim 14, wherein the electrochemically active material is selected from the group consisting of crystalline silicon, amorphous silicon, and a silicon compound.

19. The method of claim 14, wherein the electrochemically active material has a thickness in the range of between about 1 and 50 nm

20. The method of claim 14, further comprising annealing the electrochemically active material at a temperature in the range of between about 500 and 900° C. for a time of between about 4 and 16 hours.
